(19) United States
(12) Patent Application Publication
(10) Pub. No.: US 2007/0100919 A1
(43) Pub. Date: May 3, 2007

(54) Garbage collection unit and method thereof

(75) Inventors: Sang Yun Lee, Daejeon-city (KR); Hee Sun Won, Daejeon-city (KR); Sang Wook Kim, Seoul (KR); Chang Il Cha, Seoul (KR); Hyung Jun Kim, Seoul (KR); Gyu Jeong Hwang, Jinju-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/584,281

(22) Filed: Oct. 20, 2006

(30) Foreign Application Priority Data
Nov. 1, 2005 (KR) 10-2005-0103797
Dec. 15, 2005 (KR) 10-2005-0124056

(51) Int. Cl. G06F 17/30

(52) U.S. Cl. 707/206

(57) ABSTRACT

A garbage collection unit and a garbage collection method in an embedded environment are provided. In the method, a memory is divided into a young generation area including first and second areas and an old generation area including a predetermined number of blocks, the young generation area is divided into two areas, the garbage collection is performed alternately in the first and second areas of the young generation area, and the garbage collection in the old generation area is performed gradually in units of individual frames including a predetermined number of blocks. Accordingly, time delay due to garbage collection can be minimized, thereby guaranteeing a real-time operation.

### CROSS-REFERENCE TO RELATED PATENT APPLICATION

This application claims the benefit of Korean Patent Application No. 10-2005-0103797, filed on Nov. 1, 2005, and Korean Patent Application No. 10-2005-0124056, filed on Dec. 15, 2005, in the Korean Intellectual Property Office, the disclosures of which are incorporated herein in their entirety by reference.

### BACKGROUND OF THE INVENTION

1. Field of the Invention

The present invention relates to a garbage collection unit and method thereof, and more particularly, to a garbage collection unit and method capable of guaranteeing a real-time operation by decreasing delay time due to garbage collection in an embedded environment.

2. Description of Related Art

Among Java platforms, J2ME is Java technology for an embedded environment and is used for an embedded apparatus, which is connected to a network, or for a mobile device such as a smart phone, a hand-held device, a PDA, a screen phone, a set-top box, or a net-TV. The J2ME can be classified into connected limited device configuration (CLDC) and connected device configuration (CDC) platforms based on the targeting device type.

The CDLC platform is loaded and used in the type of targeting device which has a CPU, the memory or performance of which is extremely limited such as in a cellular phone and a PDA. On the other hand, the CDC platform is mainly used in the type of embedded system which has extended resources and performs relatively highly.

Generally, a garbage collector uses a method such as counting references of an object, which is called a reference counting garbage collector, marking whether an object can be reached from a root set and collecting the garbage at once, which is called Mark & Sweep, or dividing a heap memory space into two spaces and copying surviving objects in one space into the other space, which is called a semi-space copying collector.

In Java, dynamic memory allocation or garbage collection has an important influence on the performance of a device. Moreover, there are several problems in a device with an embedded environment. First, most of the embedded devices have a small memory size. Second, in a battery-operated system, power consumption is an important parameter which needs to be optimized. Third, the performance of a Java virtual machine in an embedded environment is not as good as a general system in which many native classes are supported. The embedded Java virtual machine is designed to be operated for a long time in an embedded system with a limited memory, and thus it is important to generate and manage a Java object.

### SUMMARY OF THE INVENTION

The present invention provides a garbage collection unit and a method capable of minimizing a time delay due to the garbage collection and capable of acquiring a maximal efficiency of memory.

According to an aspect of the present invention, there is provided a garbage collection unit comprising: a memory manager dividing a memory into a young generation area including first and second areas and an old generation area including a predetermined number of blocks; and a garbage collector alternately performing the garbage collection in the first and second areas of the young generation area and performing the garbage collection in the old generation in units of individual frames, each frame comprising a predetermined number of blocks.

According to another aspect of the present invention, there is provided a garbage collection method, the method including: (a) dividing a memory into a young generation area including first and second areas and an old generation area including a predetermined number of blocks; and (b) alternately performing a garbage collection on the first and second areas of the young generation area and performing the garbage collection in the old generation area in units of individual frames, each frame comprising a predetermined number of blocks.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a system performing memory management and garbage collection using a Java virtual machine according to an embodiment of the present invention;

FIG. 2 is a diagram illustrating a method of operating a generational garbage collector according to an embodiment of the present invention;

FIG. 3 is a diagram illustrating a garbage collection unit according to an embodiment of the present invention;

FIG. 4 is a diagram illustrating a memory heap structure according to an embodiment of the present invention;

FIG. 5 is a block diagram illustrating a structure of an old generation included in the memory heap structure of FIG. 4;

FIG. 6 is a diagram illustrating the performance of garbage collection frame by frame according to an embodiment of the present invention;

FIG. 7 is a method of performing write-protection using a primary filter according to an embodiment of the present invention;

FIG. 8 is a diagram illustrating a method of performing write-protection using a secondary filter according to an embodiment of the present invention;

FIG. 9 is a flowchart illustrating a method of performing garbage collection according to an embodiment of the present invention;

FIG. 10 is a flowchart illustrating a method of performing garbage collection in a young generation heap according to an embodiment of the present invention; and

FIG. 11 is a flowchart illustrating a method of performing garbage collection in an old generation heap according to an embodiment of the present invention.

### DETAILED DESCRIPTION OF THE INVENTION

A garbage collection unit and a garbage collection method according to an embodiment of the present invention will now be described more fully with reference to the accompanying drawings, in which exemplary embodiments of the invention are shown.

FIG. 1 is a block diagram illustrating a system performing memory management and garbage collection using a Java virtual machine according to an embodiment of the present invention.

When a Java virtual machine 100 receives a request for memory assignment from a Java program, a memory manager 110 assigns requested memory 130 from a memory heap, which is managed by the memory manager 110, to the application program and acquires required memory by operating a garbage collector 120 when there is not enough memory available. The memory manager 110 and the garbage collector 120 cannot be operated independently from each other. In other words, the memory manager 110 operates based on a method of performing the garbage collection used in the garbage collector 120.

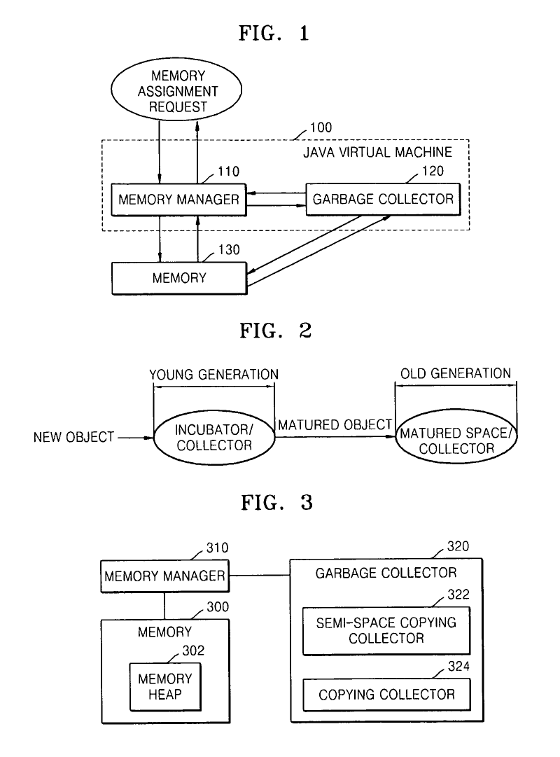

FIG. 2 is a diagram illustrating a method of operating a generational garbage collector according to an embodiment of the present invention.

In the generational garbage collector illustrated in FIG. 2, a new object is assigned from a young generation. When there is not an enough space available in the young generation, a collector of the young generation is activated, a surviving object in the young generation is copied into a mature space after the garbage collection of the collector of the young generation thereby acquiring a memory space. When a surviving object cannot be copied because the mature space is full, a garbage collector of an old generation is activated.

FIG. 3 is a diagram illustrating a garbage collection unit according to an embodiment of the present invention.

Referring to FIG. 3, the garbage collection unit includes a memory 300, a memory manager 310, and a garbage collector 320.

The memory manager 310 divides a memory heap into young generation and old generation areas. In addition, the memory manager 310 divides the young generation area into two portions and the old generation area into a predetermined number of blocks.

The garbage collector 320 applies a semi-space copying collector 322 to the young generation area and a copying collector 324 to the old generation area.

The semi-space copying collector 322 performs garbage collection in the two areas of the young generation area, that is first and second areas, alternatively. The semi-space copying collector 322 copies a surviving object to the second area when the garbage collection in the first area is performed, while the semi-space copying collector 332 copies a surviving object to the first area when the garbage collection to the second area is performed.

The copying collector 324 performs garbage collection on the old generation in units of individual frames including a predetermined number of blocks of the old generation, and copies a surviving object into a frame, called a reserved frame, in which previous garbage collection has been performed.

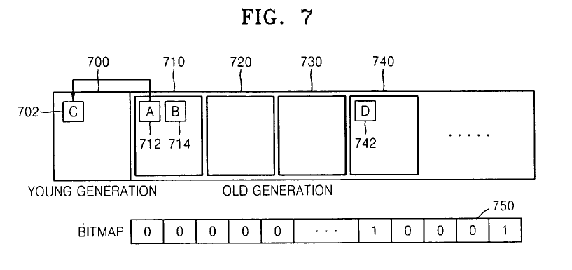

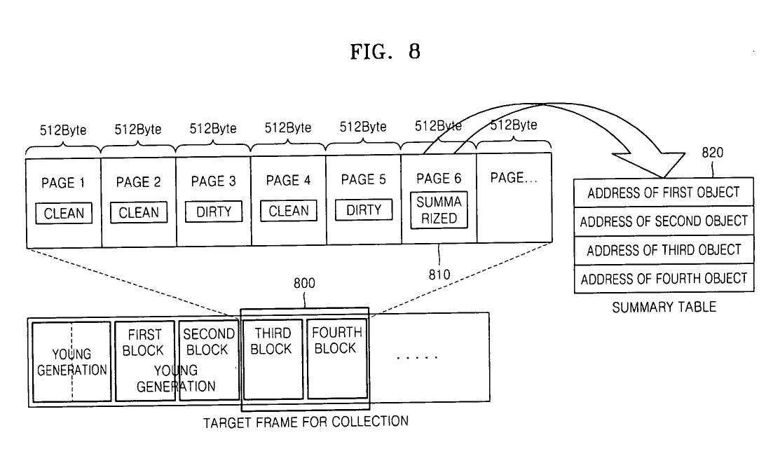

Each block of the old generation area includes a reference bit map indicating whether objects in the block are referenced by other objects. The garbage collector 320 searches for an object which is not referenced by other objects, among objects which cannot be reached from a root set, based on the reference bit map and determines that the searched object is garbage. The determination of the garbage and the search for the garbage will be described later in more detail with reference to FIGS. 7 and 8.

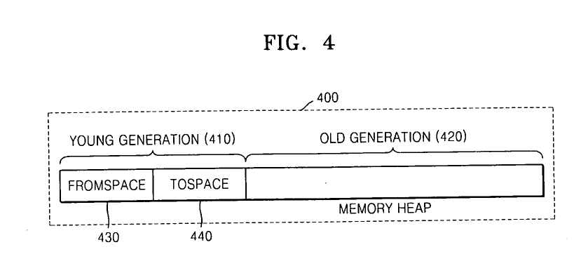

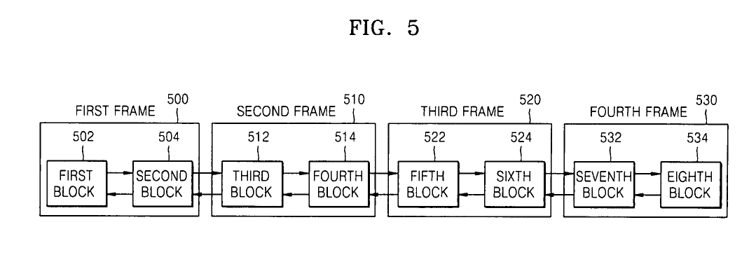

FIG. 4 is a diagram illustrating a memory heap structure according to an embodiment of the present invention.

Referring to FIG. 4, a heap 400 can be divided into a young generation area 410 and an old generation area 420. The young generation area 410 has a smaller size than the old generation area 420, thus time delay due to the garbage collection is small enough to satisfy a real-time operation.

The young generation area 410 is divided into a fromSpace 430 and a toSpace 440. The fromSpace 430 is an area which is a target for the garbage collection, and the toSpace 440 is an area into which a surviving object is copied.

When an object is moved into another area, child objects of the object should be moved together. In order to determine whether all child objects of each object are moved, a color is specified to each object. For example, a white color indicates that a corresponding object has not been searched yet, a grey color indicates that a corresponding object is searched and that all of the child objects of the object have not been searched yet, and a black color indicates that all of the child objects of the object have been searched and copied.

FIG. 5 is a block diagram illustrating a structure of an old generation included in the memory heap structure in FIG. 4.

Referring to FIG. 5, a heap of the old generation can be divided into blocks 502, 504,512, 514, 522, 524, 532, and 534, and garbage collection is performed in units of individual frames 500, 510, 420, or 530. Described in more detail, an old generation area is divided into blocks having a same size, and the blocks are linked to each other by double-linked lists. A block is a minimal unit for object assignment and garbage collection. A frame is formed by binding several blocks, and a frame becomes a target frame for the garbage collection in an order of the frames. A frame is additionally reserved so as to be used as a space into which objects are copied when the garbage collection is performed. A frame to which an object has been assigned for the longest time is selected as a target object for the garbage collection. The reason why the object becomes the target object for the garbage collection is to provide enough time for the object to die, thereby increasing a garbage collection rate, since the surviving object, which has not been collected as garbage in an initial stage after generation, has a long survival factor.

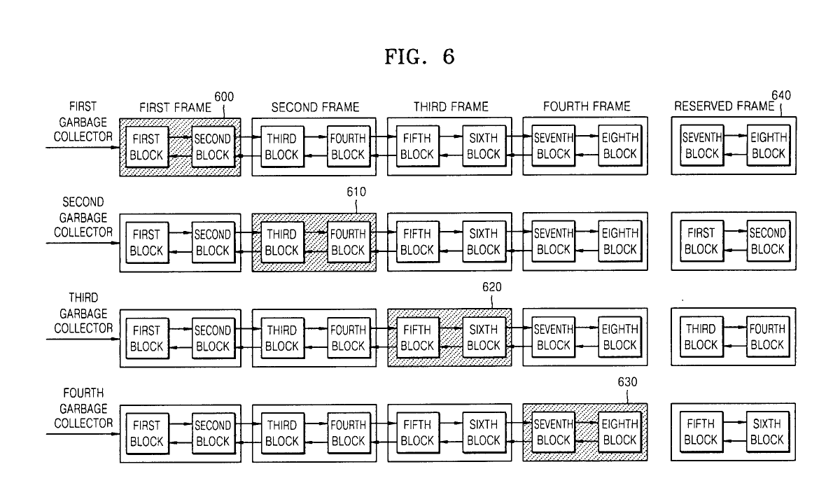

FIG. 6 is a diagram illustrating the performance of garbage collection frame by frame according to an embodiment of the present invention.

The garbage collector performs the garbage collection in a predetermined target frame at once, rather than in the total memory heap, and thereafter moves to the next target frame. In other words, the garbage collector performs a first garbage collection in a first frame 600 and thereafter performs a second garbage collection in a second frame 610. In this way, the garbage collector performs the garbage collection in third and fourth frames 620 and 630, respectively.

In a memory heap of the old generation, a reserved frame 640 exists, and a surviving object, after the garbage collection is performed, is copied into the reserved frame 640. After the garbage collection is performed on the predetermined frame, the predetermined frame in which the garbage collection is performed becomes the reserved frame 640. A vacant block included in the reserved frame 640 is divided in order to have a free space into which a new object is copied.

Whether an object is garbage or not is determined based on whether the object can be reached from a root set. However, an object which is referenced by another object, although the object cannot be reached from the root set, should not be regarded as garbage.

To prevent an object referenced by another object from being regarded as garbage, all objects included in the memory heap should be checked to determine whether the objects are referenced by another object. However, a conventional method takes a lot of time in checking whether an object is referenced, and accordingly the conventional method is not suitable for an embedded environment requiring a real time operation.

FIG. 7 is a method of performing write-protection using a primary filter according to an embodiment of the present invention.

A problem whereby an object referenced by another object becomes garbage, that is, a problem of a write-barrier, occurs in two cases. A first case occurs when an object of a young generation, which is referenced by an object of an old generation, becomes a target for the garbage collection. A second case occurs when an object of a frame targeted for the garbage collection is referenced by a block of a different frame, when the garbage collection is performed in the old generation.

Referring to FIG. 7, a case when an object A 712 of a predetermined block 710 of an old generation referring to an object C 702 of a young generation corresponds to the first case, and a case when an object B 714 of a predetermined block 710 of an old generation referring to an object D 742 of a different block 740 corresponds to the second case.

A header of each block 710,720,730, or 740 of a memory heap includes a reference bit map 750, and the reference bit map 750 indicates whether there is an object in the corresponding block, in which the reference bit map 750 is located, referenced by an object of a different generation or an object of a different block of the same generation. For example, a one in the reference bit map 750 indicates that there is a referenced object, while a zero in the reference bit map 750 indicates that there is no referenced object. Thus, the number of blocks to be checked can be decreased using the reference bit map 750.

Although blocks to be checked are determined by the primary filter using the reference bit map 750, many objects can be included in a block, and thus checking all the objects takes a lot of time. Accordingly, a secondary filter is required.

FIG. 8 is a diagram illustrating a method of performing write-protection using a secondary filter according to an embodiment of the present invention.

Each block 800 is logically divided into pages 810, a reference status for each page is stored, and a searching operation for an object can be changed according to the corresponding stored reference status.

Referring to FIG. 8, the reference status information of each page is one of CLEAN, DIRTY, and SUMMARIZE. The reference status of CLEAN indicates that there is no reference from a corresponding page to a different block. The reference status of DIRTY indicates that the number of objects referenced from the corresponding page to a different block is equal to or larger than five. The reference status of SUMMARIZE indicates that the number of objects referenced from the corresponding page to a different block is equal to or smaller than four.

When the reference status is CLEAN, the corresponding page is not searched, and when the reference status is DIRTY, all objects in the corresponding page should be searched. When the reference status is SUMMARIZE, an address of an object which refers to a different block is stored in a separate summary table 820, so that the object can be acquired in a speedy manner. The address of an object which refers to an object in a different block can be acquired easily and quickly using the summary table 820.

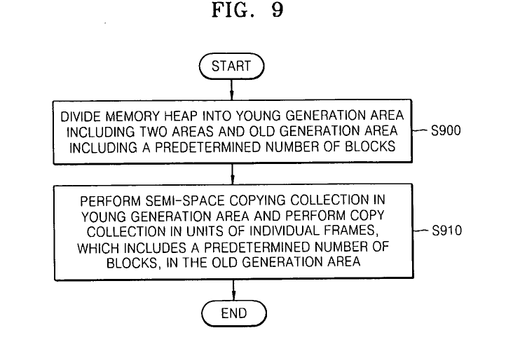

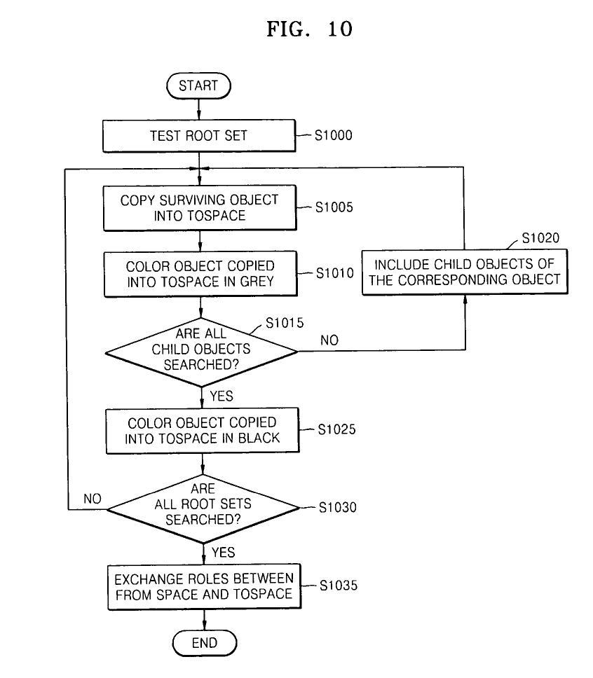

FIG. 9 is a flowchart illustrating a method of performing garbage collection according to an embodiment of the present invention.

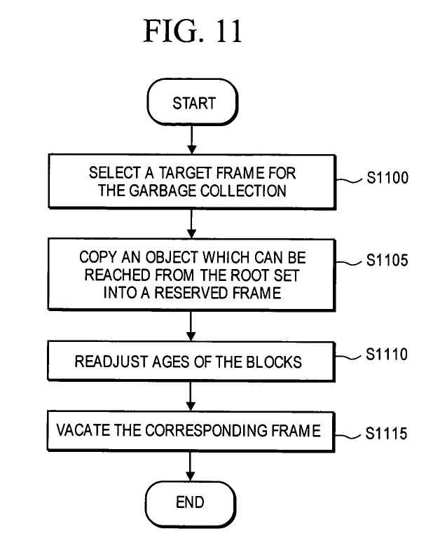

Referring to FIG. 9, at first, a memory heap is divided into a young generation area including two areas and an old generation area including a predetermined number of blocks (S900). Of the divided memory spaces, a garbage collector performs a semi-space copying collection in the young generation area and performs a copy collection in units of individual frames, which include a predetermined number of blocks, in the old generation area (S910). The method of performing the garbage collection will now be described in more detail with reference to FIGS. 10 and 11.

FIG. 10 is a flowchart illustrating a method of performing garbage collection in a young generation heap according to an embodiment of the present invention.

Referring to FIG. 10, a garbage collector at first tests a root set including a stack (S1000). The garbage collector checks whether objects in a fromSpace space of the young generation heap can be reached from the root set. Objects which cannot be reached from the root set are determined to be garbage and immediately collected, while surviving objects, which have not been collected, are copied into a toSpace (S1005).

The objects which have been copied into the toSpace have not been fully searched, including child objects of the objects, and accordingly painted in grey as described with reference to FIG. 3 (S1005). The object painted in grey is checked as to whether all of the child objects of the object are searched (S1015). When all of the child objects together with the object have not been searched, all of the child objects are included in the root set (S1020). On the other hand, when all of the child objects together with the object have been searched, the object is painted in black indicating that the object together with the child objects of the object have been searched (S1025).

When the searches for all the root sets are completed (S1030), roles of the fromSpace and the toSpace are exchanged with each other (S1035). Accordingly, the next garbage collection is performed in the toSpace, a surviving object is copied into the fromSpace, and thereafter the roles of the toSpace and fromSpace are exchanged with each other again.

FIG. 11 is a flowchart illustrating a method of performing garbage collection in an old generation heap according to an embodiment of the present invention.

Referring to FIG. 11, the garbage collector at first selects a target frame for the garbage collection (S1100). As described above, the target frames for the garbage collection are sequentially ordered in order of the frames. An object which can be reached from the root set, among objects in blocks of the target frame, is copied into a reserved frame (S1110). When the copy is completed, ages of the blocks are readjusted (S920) and the corresponding frame is vacated (S1130).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion.

A garbage collector according to an embodiment of the present invention is capable of minimizing delay time due to garbage collection, and is thereby suitable for an embedded environment requiring a real-time operation. In addition, the garbage collector can acquire a maximal efficiency of memory and can be loaded in a Java virtual machine for operating Java applications, thereby operating Java applications rapidly in various embedded apparatuses.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A garbage collection unit comprising:
a memory manager dividing a memory into a young generation area comprising first and second areas and an old generation area comprising a predetermined number of blocks; and
a garbage collector alternately performing the garbage collection to the first and second areas of the young generation area and performing the garbage collection to the old generation in units of individual frames, each frame including a predetermined number of blocks.

2. The garbage collection unit of claim 1, wherein the garbage collector comprises a semi-space copying collector copying a surviving object into the second area of the young generation when the garbage collection is performed in the first area and copying a surviving object into the first area of the young generation when the garbage collection is performed in the second area.

3. The garbage collection unit of claim 1, wherein the garbage collector determines an object which cannot be reached from a root set, among objects of the young generation area, to be garbage.

4. The garbage collection unit of claim 1, wherein the garbage collector divides objects of the young generation area into objects which are not checked as to whether the objects can be reached from a root set, objects which can be reached from the root set and of which child objects are not searched, and objects which can be reached from the root set and of which child objects are searched.

5. The garbage collection unit of claim 4, wherein the garbage collector distinguishes the objects of the young generation area by colors.

6. The garbage collection unit of claim 1, wherein the garbage collector comprises a copying collector copying a surviving object into a frame in which a previous garbage collection is performed after the garbage collection is performed in units of individual frames, which includes a predetermined number of blocks of the old generation area.

7. The garbage collection unit of claim 1, wherein the garbage collector sequentially performs the garbage collection in the frames of the old generation area.

8. The garbage collection unit of claim 1, wherein the garbage collector determines that an object which cannot be reached from a root set, among objects located in blocks of a target frame for the garbage collection, is garbage.

9. The garbage collection unit of claim 1, wherein each block of the old generation area comprises a reference bit map indicating whether objects in the block are referenced by different objects, and
wherein the garbage collector searches for an object not referenced by a different object among objects which cannot be reached from a root set based on the reference bit map and determines that the searched object is garbage.

10. The apparatus of claim 1, wherein the garbage collector comprises a reference bit map dividing each block of the old generation area into units of a predetermined page and indicating whether the object in the block is referenced by a different object, and
wherein the garbage collector searches for an object not referenced by a different object among objects which cannot be reached from a root set based on the reference bit map and determines that the searched object is garbage.

11. The apparatus of claim 10, wherein the reference bit map indicates a status in which a predetermined page is not referenced by a different object and a status in which the predetermined page is referenced by a predetermined number or more of objects or the predetermined number or less of objects.

12. A garbage collection method, the method comprising:
(a) dividing a memory into a young generation area comprising first and second areas and an old generation area comprising a predetermined number of blocks; and
(b) alternately performing a garbage collection in the first and second areas of the young generation area and performing the garbage collection in the old generation area in units of an individual frame, each frame including a predetermined number of blocks.

13. The garbage collection method of claim 12, wherein (b) comprises:
(b1) copying a surviving object into the second area of the young generation when the garbage collection in the first area is performed, and copying a surviving object into the first area of the young generation when the garbage collection in the second area is performed; and
(b2) copying a surviving object into a frame in which previous garbage collection is performed after the garbage collection is performed in units of individual frames, each frame including a predetermined number of blocks of the old generation area.

14. The garbage collection method of claim 12, wherein (b) comprises dividing objects of the young generation area into objects which are not checked as to whether the objects can be reached from a root set, objects which can be reached from the root set and of which child objects are not searched, and objects which can be reached from the root set and of which child objects are searched.

15. The garbage collection method of claim 12, wherein (b) comprises sequentially performing the garbage collection in the frames of the old generation area.

16. The garbage collection method of claim 12, wherein (b) comprises searching for an object not referenced by a different object among objects which cannot be reached from a root set based on the reference bit map, which is included in each block of the old generation area, indicating whether the object in the block is referenced by a different object and determining that the searched object is garbage.

17. The garbage collection method of claim 12, wherein (b) comprises dividing each block of the old generation area into units of a predetermined page, searching for an object not referenced by a different object among objects which cannot be reached from a root set based on a reference bit map indicating in units of the predetermined page whether the object in the block is referenced by a different object, and determining that the searched object is garbage.
